(19) United States
(12) Patent Application Publication
(10) Pub. No.: US 2005/0105706 A1
(43) Pub. Date: May 19, 2005

(54) Method and apparatus for providing pre-connection messaging and output

(76) Inventor: Antti Kokkinen, Espoo (FI)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/948,800

(22) Filed: Sep. 24, 2004

Related U.S. Application Data
(60) Provisional application No. 60/505,841, filed on Sep. 26, 2003.

(51) Int. Cl. H04M 3/42

(52) U.S. Cl. 379/201.01; 379/207.13

(57) ABSTRACT

A method and apparatus for providing pre-connection messaging and output are provided. In an intelligent network (IN), a party initiating a communication link is presented with a message, an announcement, or other output, which can include audio, visual, or audio/visual output. While a communication link (e.g., a telephone call) an initiating party is attempting to establish via the IN is in the setup stage (e.g., the IN is attempting to connect the call), output is provided to the initiating party, such as in the form of a personalized “ringback” tone (PRBT) or other suitable output in addition to or in place of a standard ringing tone (RBT). The output is provided based on a subscriber's preferences and according to one or more parameters or rules set by the subscriber, which is the receiving party to the communication link

### PRIORITY

This application claims the benefit of U.S. Provisional Application No. 60/505,841, filed on Sep. 26, 2003, the entire disclosure of which is incorporated herein by reference.

### FIELD OF THE INVENTION

The present invention relates to a service provided in connection with the establishment of a communication link. More specifically, the present invention relates to messaging or output that can be provided to a party initiating a communication while a network attempts to establish a communication link to an intended communication partner. The messaging or output that is provided to the initiating party can be selected in advance or uploaded by the party being contacted.

### BACKGROUND

There are many communication media for establishing real time communication between parties. Examples of such media include fixed line telephone service, wireless telephone service, instant messaging services via data networks, etc. In some of these environments, a first party initiates the establishment of a communication link between themselves and a destination party. The establishment of the communication link may take some time period that introduces a connection delay that is perceptible to the initiating party. In such circumstances it is common for the communication networks to provide the initiating party with some sort of feedback while the network attempts to establish the communication link. In the telephone network environment the initiating party is often referred to as a calling party and the intended destination is referred to as the called party. In the telephone network environment, a well-known example of feedback to the calling party is the provisioning of a ringing tone that is sent to or played for the calling party after the calling party initiates establishment of the communication link and prior to the called party actually answering the communication attempt.

It is also known that networks may provide functionality above and beyond the establishment of communication links. For example a network may allow a subscriber to receive information about the party initiating the communication, e.g., calling party ID, or set certain filters for call handling. In the telephony environment these are functions often associated with an Intelligent Network (IN). In one example of an IN, the calling party attempts the communication, the IN analyzes the input information from the calling party, such as the called party identification number entered by the calling party, as well as information derived from the calling party, for example, the calling party identification information. The IN can use such pieces of information, along with other data to appropriately process the communication request from the calling party to the called party.

One IN system replaces a ringing tone otherwise supplied to the calling party, with a selected advertisement or some other message while the network attempts to establish the communication link to the called party. This advertisement or announcement is determined by the network and often times is only provided when there has been an agreement between the calling party and the network service provider whereby the calling party agrees to receive such advertisements or messages in return for a special rate for the service of providing the communication links on behalf of the calling party. Thus, message or announcement feedback mechanisms have been adjusted in the network environment, but only from the perspective of a relationship between the calling party and the network.

### SUMMARY

In accordance with an aspect of the present invention, an intended destination party can be a subscriber to a service in which that party can select the an audio, visual, or audio/visual output or message to be provided to a communication initiator as a network attempts to establish a communication link between the initiator and the destination party. According to an embodiment, the destination party can select from among multiple audio and/or visual resources and can associate a selected resource with a given initiating party identifier or group identifier. Additionally, or alternatively, the destination party, which can be a subscriber to services of the network, can upload audio and/or visual message or output, which can be associated with a given initiating party identifier or a group identifier.

When an initiating party attempts to establish a communication link with the subscriber as a destination party, the network identifies the destination party as a subscriber, retrieves an appropriate audio and/or visual message or output based on information associated with the destination party identifier and the initiating party identifier. The network then can provide the audio and/or visual message or output to the initiating party until the connection to the destination party is established by the network. The network can determine that the communication link has been established at the time that the destination party answers the communication request.

In a telephone communication environment, for example, an embodiment of the invention employs capabilities associated with an intelligent network (IN) to detect destination party and initiating party identification information and then performs database lookups to determine an audio and/or visual message or output to be presented to a calling or initiating party. For example, audio output, such as musical selections, can be played to a calling or initiating party based on an assignment or selection of the audio output by the destination party and/or additional parameters. The audio output (similarly to other output according to other embodiments of the invention) can be provided according to a variety of predetermined rules, such as rules relating to individual initiating parties, groups of initiating parties, timing rules, special occasion rules, gift service rules, or other rules desired by the subscriber.

### BRIEF DESCRIPTION OF THE DRAWINGS

The present invention will be further described below with references being made to the attached drawings.

FIG. 1 is a block diagram illustrating a background network configuration in which an embodiment of the invention can be deployed.

FIG. 2 is a block diagram illustrating components of one of the components of FIG. 1.

FIG. 3 is a block diagram illustrating a network arrangement according to an embodiment of the invention.

FIG. 4 illustrates a call processing operation according to an embodiment of the invention.

FIG. 5 is a block diagram illustrating a network arrangement according to an embodiment of the invention.

FIG. 6 illustrates a call processing operation according to an embodiment of the invention.

FIG. 7 is a block diagram showing network components and communications protocols used by those components according to an embodiment of the invention.

### DETAILED DESCRIPTION

One or more embodiments of the invention provide a method and/or apparatus for providing pre-connection messaging and output. For example, according to one or more embodiments of the invention, an initiating or calling party attempting to call a subscriber of a telecommunications network can be provided with or played a message, announcement, or other output, such as an audio output, visual output, or audio/visual output, previously uploaded or selected by a subscriber. For example, rather than hearing a ringing tone, a user can be presented with audio output in the form of a voice message, a musical selection, or the like. Additionally, or alternatively, visual display data or combined audio/visual data can be provided to a user attempting to call a subscriber of a telecommunications network.

Thus, for example, a subscriber of a service, according to one or more embodiments of the invention, can select or provide (e.g., upload) a message, announcement, or other output (e.g., a musical selection) to be played or output to an initiating or calling party instead of a ringing tone. This output can be played or output to the calling party when calling the subscriber and prior to connection of the call to the subscriber. For example, musical selections can be provided as personalized “ringback” tones (PRBT), which are played instead of standard ringing tones (RBT) that are generally provided in telecommunications networks to indicate that a call is being connected.

The audio, visual, or audio/visual output provided according to one or more embodiments of the invention can be highly configurable, as a user can determine a variety of parameters associated with the output and how it is to be played or provided to a calling party. For example, a husband can select a song having special or sentimental meaning to his wife to be played in place of a ringing tone when his wife dials his number. In such a situation, rather than hearing a ringing tone when the wife calls the husband's number, she will instead hear the special, sentimental musical selection. Specific outputs to be provided as personalized ringback tones (PBRT), or other output information, can be specified for any number of potential calling parties that may attempt to call the subscriber.

Additionally, groups of subscribers can be associated with a particular output. For example, a subscriber can associate a group of college roommates with a college fight song to be output as a personalized ringback tone (PRBT) in place of the standard ringing tone (RBT) whenever one of the group of college roommates attempts to call the subscriber. Similarly, a family crest can be transmitted to the phone of a caller that is associated with a group indicating that that caller is a member of the subscriber's family. Additionally, a variety of types of output can be provided, such as inspirational quotes, audio from comedy routines, movie clips, or any other information desirable to be transmitted during a call-setup period.

In addition to providing caller-based or group-based output, output provided by one or more embodiments of the invention can be time-based, such that output varies according to the time at which it is provided (e.g., according to a time of day, a day of a week, a season, etc). For example, audio output associated with a particular day of the week (e.g., an audio clip of a comedy routine about difficult Mondays, a song about Fridays, etc.) can be played for identified calling parties (or all calling parties) when a subscriber is called on that day of the week.

Similarly, output provided to the calling party can be occasion-based, such that when a calling party attempts to call a subscriber on a predefined occasion, a unique, occasion-based output associated with the predefined occasion is provided to the calling party. For example, if a calling party attempts to call a subscriber on the user's birthday, and the subscriber has associated an occasion-based ringback tone (e.g., the song “Happy Birthday”) with that special occasion for that calling party, the occasion-based ringback tone can be played to the calling party in the place of a standard ringing tone on the day of the special occasion. Similarly, a subscriber can customize the output, such as occasion-based output according to a variety of rules. For example, a calling party can be associated with an occasion-based ringback tone (e.g., the song “Happy Birthday”) beginning on a day of a special occasion and going forward for a predetermined amount of time, or indefinitely until the calling party calls for the first time after the occasion-based ringback tone is played for the calling party.

Any output (e.g., audio, visual, or audio/visual output) provided to a caller can be selected from a pre-stored list of outputs available via the network. Additionally, or alternatively, information can be uploaded or otherwise provided by a user, either using a communications device (e.g., a wireless or mobile telephone, etc.), or another suitable device, such as a computer, or the like. Output provided to a caller can be made available for the caller to copy, such that the caller can copy and use the output at a later time. For example, if a song having particular sentimental meaning is played to a caller as a ring-back tone, the caller can copy the sound clip while listening to it for later playback or other use. Additionally, a subscriber of the network can select an output (e.g., an audio clip, etc.) and sent it to another entity, which need not be a subscriber to the same network communications system, via a suitable transmission method, such as short message service (SMS), for example. Likewise, in addition to being able to copy the output (e.g., an audio clip), a user can add the output to the user's library, such as a personal photo album, a personal music library, or the like.

In the description that follows, terms such as “subscriber” and “party” are sometimes used to describe individuals accessing a network (e.g., communications or telecommunications network). Additionally, the same terms such as “subscriber” and “party” are sometimes used to describe devices by which such individuals access a network. Because of the vastly differing capabilities of individuals and devices with respect to network communications or services, it is generally clear how the terms are being used; however, to the extent that usage of such terms can be construed to apply to both individuals and devices, it should be so construed. Although such terms are at times used herein to describe devices, at other times, such devices are differentiated from the individuals or explicitly described.

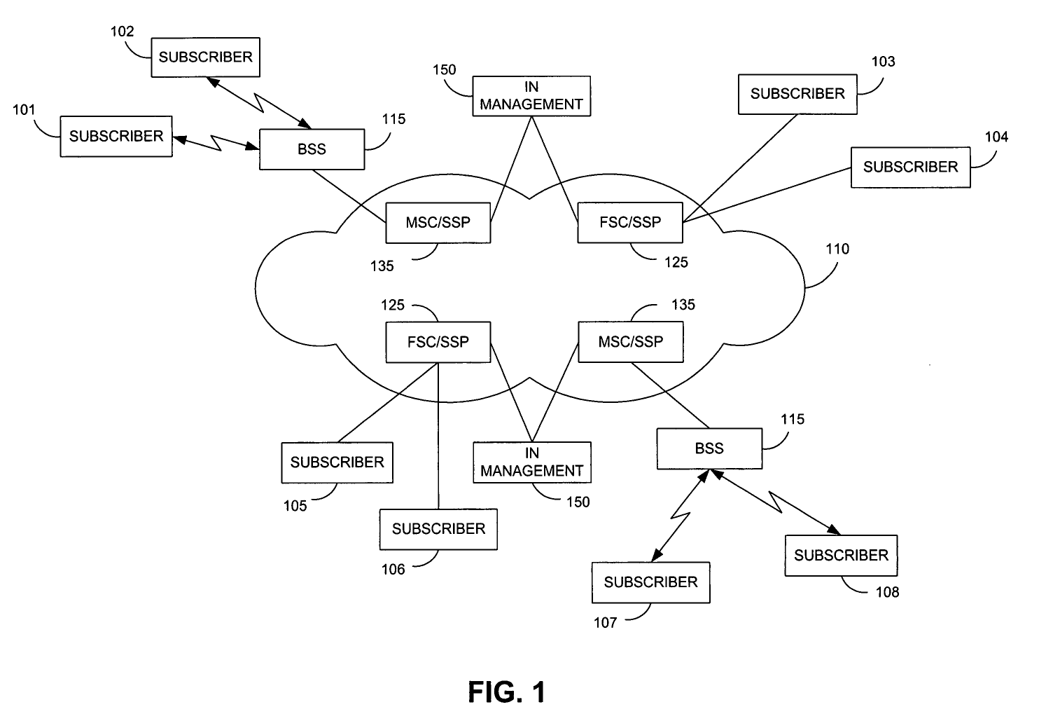

FIG. 1 is a block diagram illustrating a background network configuration in which an embodiment of the invention can be deployed. More specifically, FIG. 1 provides an illustration in a schematic form of an arrangement for communicating between and among a number of communication services subscribers 101-108, according to an embodiment of the invention. In this configuration, the communication can occur between subscribers via a network 110. For purposes of illustration, the following embodiments are described in connection with a telephone communication system; however, the principles of the invention have applicability in other communication systems where a network must establish or set up a link between two or more communication parties.

In the example network 110 shown in FIG. 1, there are switching controls such as mobile switching control (MSC) 135 (sometimes also referred to as a mobile switching center) or fixed-wire switching control (FSC) 125 (sometimes also referred to as a fixed-wire switching center) within (and sometimes referred to as being “at the edge of”) the network 110. All of these switching controls are also referred to as service switching points (SSPs) because the network 110 can be considered an intelligent network (IN), such as a telephone network using the Signaling System 7 (SS7) protocol.

Intelligent networking in the telephone communication context has provided flexibility in terms of services that might be provided to either a calling party or a called party. For example, it is known to use intelligent network communications capabilities to analyze a called party number alone or use the called party number along with the calling party number to determine how to properly route a telephone call request. For example, a given called number may be a “1-800” number that can be serviced from a plurality of different regions (e.g., by entities local to each region), depending upon the region in which the calling party is located.

Using another intelligent network (IN) functionality, a calling party can subscribe to a telecommunications service whereby, in exchange for a reduced rate charged for connections, the calling party accepts that the network will play some message and/or advertisement prior to connecting the requested call from the calling party to the called party. These intelligent network (IN) configuration functions can be performed using database lookups (e.g., lookup keys). Database lookups, such as lookup keys, can be, for example, information like the called party number and/or the calling party number, which can be considered inputs for determining what services apply to a given service request.

In the arrangement shown in FIG. 1, some of the subscribers can be connected to the network 110 via wireless connections such as the wireless subscribers 101, 102, 107, and 108. In such circumstances, a wireless subscriber typically communicates with an intermediary component such as a base station subsystem (BSS) 115. The base station subsystem (BSS) 115 can connect to an MSC/SSP 135, thereby providing a communication link into the network 110. Other subscribers can be connected to the network 110 by fixed-wire connections, such as wired subscribers 103, 104, 105, and 106, for example. In such circumstances, these subscribers are coupled to an FSC/SSP 125. The “edge-of-the-network” switching service points (SSPs) then operate under the control of intelligent network (IN) management infrastructure 150, by which they can appropriately route calls either initiated by a subscriber or directed to a subscriber, which have been initiated elsewhere in the network 110.

For example, if a wireless subscriber 108 (the initiating subscriber, in this case) wishes to initiate a call to another subscriber 103 (the receiving subscriber, in this case) via the network 110, the initiating subscriber 108 initiates a communication with its associated BSS 115, and the BSS 115, in turn, communicates with the associated MSC/SSP 135. In an intelligent network (IN) configuration, such as the configuration shown in FIG. 1, the MSC/SSP 135 then communicates with the IN management infrastructure 150 to obtain information relating to processing the call from the initiating subscriber 108. Upon receipt of information about call processing operations, the MSC/SSP 135 operates in accordance with instructions provided by the intelligent network (IN) management infrastructure 150 to route the call ultimately to the edge-of-the-network FSC/SSP 125 coupled to or otherwise associated with the receiving subscriber 103. In this latter stage of the link building process, the receiving subscriber 103 is notified of the communication request from initiating subscriber 108 (e.g., using a paging signal or telephone ring). If the receiving subscriber 103 accepts the communication request or, in telephone network parlance, answers the call, then a communication link is established between the initiating subscriber 108 and the receiving subscriber 103.

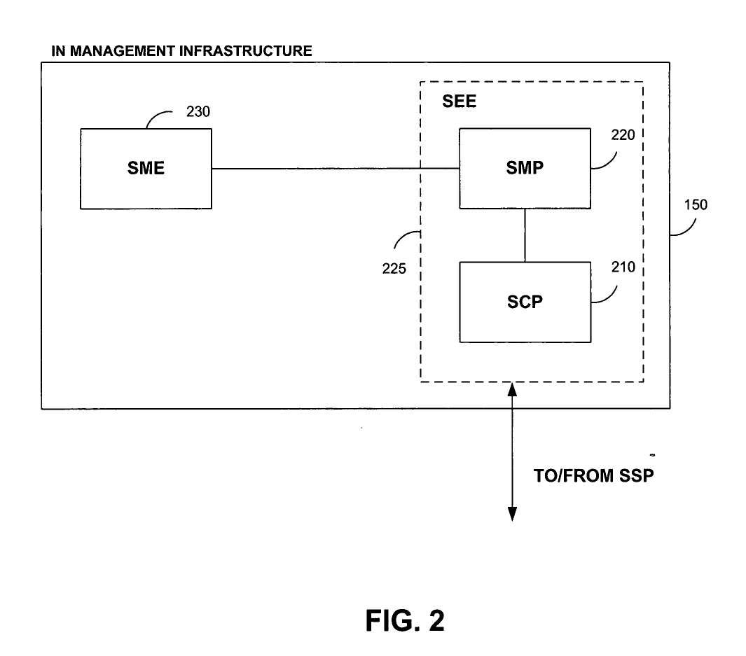

FIG. 2 is a block diagram illustrating components of one of the components of FIG. 1. More specifically, the intelligent network (IN) configuration shown in FIG. 1 can employ a structure such as that illustrated in FIG. 2 as part of the intelligent network (IN) management infrastructure or component 150. The structure shown in FIG. 2 can include a service control point (SCP) 210, which can communicate messages back and forth with a service switching point (SSP), such as the SSPs 125, 135 shown in FIG. 1. The service control point (SCP) 210 operates in conjunction with a service management point (SMP) 220 to provide a service execution environment (SEE) 225 for providing a desired intelligent network service. A service management environment (SME) 230 can interface with this service execution environment (SEE) 225 or its components by providing an interface to the service management point (SMP) 220, for example.

The service management environment (SME) 230 can control operations for determining the network functionality that will be accessible to subscribers and the conditions for executing that functionality. This service management environment (SME) 230 can also provide inputs to the service execution environment (SEE) 225, which can provide any necessary controls on a real-time basis as communication requests are fielded by the respective edge-of-the-network components, such as the service switching points (SSPs) 125, 135. Therefore, in processing intelligent network (IN) functionality, an SSP 125 or 135 (shown in FIG. 1) communicates with the SCP 210, and provides information, such as a calling party identifier and a called party identifier. The SMP 220 receives information from the SCP 210, and can process it in accordance with rules determined by the SME 230. The SMP 220 can then instruct the SSP 125 or 135 (e.g., via the SCP 210) on how to appropriately process the communication request and/or control the response of the SSP 125 or 135.

In accordance with an embodiment of the invention, a network management operation provides messaging to the party initiating a communication (sometimes referred to as a calling party, an initiating party, an initiating subscriber, etc.) prior to establishment of the communication link. In this embodiment the message can be, for example, an audio-only message, a visual-only message, or an audio/visual message that is provided to the party initiating the communication link in accordance with instructions defined by the intended recipient subscriber of the communication (sometimes referred to as a called party, a receiving party, a receiving subscriber, a destination party, etc.).

In a network, such as the network 110 illustrated in connection with FIG. 1 and FIG. 2, the initiating party is often referred to as the calling party while the destination party is often referred to as the called party. In this arrangement, an embodiment of the invention can replace a ringing tone ordinarily provided to the calling party with a specially selected message or output in accordance with instructions provided by the called party. Specifically, in a subscription-setup mode, a subscriber can identify particular messages, types of messages, output, or types of output to be played to those parties attempting to contact the subscriber or called party. In addition, the subscriber can associate particular identifiers (e.g., individual calling party identifiers or group identifiers) with particular messages. For example, a subscriber can indicate that a call from a given calling party will receive a particular message or output when attempting to call the subscriber. Likewise, a subscriber can indicate that a call from any member of a particular group of calling parties will receive the same message associated with that group (e.g., using a group identifier) while the network 110 attempts to establish a connection to the called party from the calling party. The message or output provided can be an audio message or output, a visual message or output, an audio/visual message or output, or any other desirable type of message or output.

In an intelligent network (IN) configuration, such as the configuration described above, the intelligent network (IN) can receive called party information (e.g., in the form of a called party ID or a called party telephone number) during call setup or initiation, and can determine if the called party subscribes to a pre-connection messaging service. In addition, the intelligent network (IN) receives the calling party identification information (e.g., in the form of a calling party ID or caller ID that can include a calling party telephone number) and determines whether the subscriber has identified the calling party (e.g., as an individual or as a member of a group) to be the recipient of a particular message or output during the call setup process. If the intelligent network (IN) determines that the called party is a subscriber, and that the called party has identified, selected, or created a particular message or output to be played or provided to the calling party attempting to communicate with the called party, then the intelligent network (IN) will forward the corresponding message to the calling party while, in the interim and substantially concurrently, the intelligent network (IN) attempts to establish the requested communication link to the called party. When the called party answers, or in other words, when a communication link is established between the called party and the calling party, the intelligent network (IN) terminates the message or output be played or provided to the calling party. The termination of the message or output can, optionally, be delayed until an appropriate time, such as a stopping or other predetermined point in the message or output.

According to an embodiment of the invention, a subscriber is provided with a range of alternatives for messages that can be made available for playing to calling parties. For example, the intelligent network (IN) configuration can provide a plurality of musical selections in a resource database. Each musical selection can be associated with an index or reference identifier. A subscriber can link one of the indices or reference identifiers with a given calling party number or calling party ID. Alternatively, the subscriber can create a list of calling party numbers or calling party IDs to be treated identically and associated with a common musical selection such that the same index or reference identifier is associated with the entire group. This can occur, for example, by linking a group calling party ID or group ID to an index or reference identifier of a musical selection, or by individually linking each calling party ID of each individual calling party in the group of calling parties with an index or reference identifier of a common musical selection. In such an embodiment, a musical selection will be played to the calling party when the calling party attempts to initiate a communication link with (e.g., places a telephone call to) the subscriber.

In an alternative arrangement, the intelligent network (IN) can store messages, announcements, or other output supplied by the subscriber, instead of or in addition to providing multiple, previously stored messages, announcements, or outputs selectable by the subscriber. Thus, for example, a subscriber can upload musical selections, voice instructions, visual messages or output, audio/visual output, or other output to the intelligent network (IN), and in particular to a resource point within the intelligent network (IN). This uploaded output or output that is selected from a group of previously stored output selections provided by the service provider can be associated with a given calling party or group of calling parties by a subscriber. As a consequence, the associated information is conveyed or relayed (e.g., played, displayed, transmitted, etc.) to a calling party during the call setup process in a manner similar to that described above.

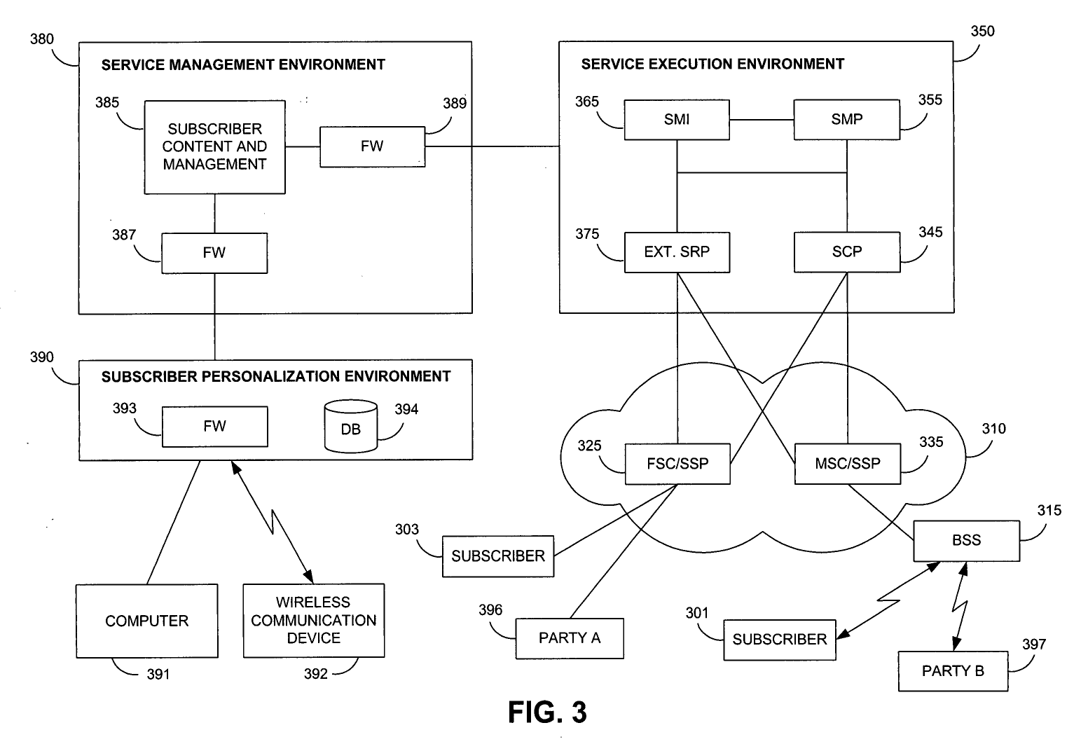

A more particular embodiment of the invention in connection with the architecture for an intelligent network (IN) shown in FIG. 1 and FIG. 2 is described with reference to FIG. 3, which is a block diagram illustrating a network arrangement according to this embodiment.

In the embodiment shown in FIG. 3, two subscribers to the intelligent network service that provides pre-connection messages or output are shown: one is a wireless subscriber 301 and the other is a fixed-wire-line subscriber 303 (also referred to as a wired subscriber). While only two subscribers are shown, many subscribers (including wireless subscribers and wired subscribers) can access the functionality of the intelligent network service described in connection with FIG. 3. The subscribers shown in FIG. 3 are connected into the network 310 in a manner similar to that illustrated in FIG. 1 and described above in connection therewith. For example, the wireless subscriber 301 communicates via a base switching subsystem (BSS) 315 with an MSC/SSP 335. The fixed-wire-line subscriber 303 is connected into the network via an FSC/SSP 325. With the exception of how each subscriber 301, 303 accesses the network 310, the functionality accessed by and provided for each of the subscribers 301, 303 and the respective communications devices of each subscriber 301, 303 is substantially similar. Accordingly, while some functions are described with respect to only one type of subscriber, they generally apply to both types of subscribers 301, 303, or in other words, most functions of the network 310 shown in FIG. 3 are similar for both wireless and wired or fixed-wire-line subscribers with the general exception of how the devices of the subscribers access the network 310.

Additional network 310 users, Party A 396 and Party B 397, are also shown in FIG. 3. These additional users have not been identified as subscribers because, according to one or more embodiments of the invention, a calling party need not be a subscriber to the pre-connection message service or to any other intelligent network service to receive a message or other output provided according to one or more embodiments of the invention. In operation, Party A 396 may be a calling party attempting to establish a communication link via the network 310 with the wireless subscriber 301.

For the purposes of illustration, the wireless subscriber 301 is assumed to be a communication entity or individual using the pre-connection messaging service according to one or more embodiments of the invention. As Party A 396 attempts to make the call to wireless subscriber 301, the communications device associated with Party A 396 (e.g., a telephone or other wired communications device) provides signaling to its associated FSC/SSP 325. The FSC/SSP 325 detects at least two pieces of information: an identifier of Party A, such as a calling party number or identifier (e.g., a calling party ID); and an identifier of the intended destination of the communication, or identifier (e.g., the telephone number of the called party or other called party ID) associated with wireless subscriber 301. Information provided to the FSC/SSP 325 is transferred to the service control point (SCP) 345 in the service execution environment (SEE) 350. This service execution environment (SEE) 350 can reside either proximate to or distant from FSC/SSP 325, depending upon the particular implementation.

In the embodiment shown in FIG. 3, the FSC and MSC can be at distinct locations and can both be in communication with the same service execution environment (SEE) 350. Additionally, or alternatively, it is possible that this service execution environment (SEE) 350 can be proximate to one of the FSC and the MSC, and distant from the other, or it can be distant from both SSPs.

Upon receipt of information from the FSC/SSP 325, the service control point (SCP) 345 sends a query to the service management point (SMP) 355. The service management point (SMP) 355 then uses the received information to determine whether or not the identification number associated with the intended destination of the call (e.g., a called party ID or telephone number of the called party), is associated with a subscriber to the pre-connection messaging service or to any other intelligent network service. Once the SMP 355 determines that the called party is a subscriber, the SMP 355 then uses identification information associated with the calling party (e.g., a calling party ID or identification number) as a search key or identifier to determine what service will be provided to the calling party on behalf of the subscriber. More specifically, the SMP 355 determines what, if any, message or output is associated with the identification information associated with the calling party (either individually or in a group), and provides that message or output to the calling party.

According to one or more embodiments of the invention, the SMP 355 uses the calling party ID to select an appropriate audio, visual, or audio/visual message or output to be provided or played to the calling party while the network continues the setup process in an attempt to establish the connection to a subscriber (e.g., the wireless subscriber 301). An external specialized resource point (SRP) 375 is used as a repository for the messages, announcements, or other output that will be presented to calling parties. The SMP 355, thus, operates to select the appropriate message, announcement, or other output from the SRP 375 for transmission to the calling party based on one or more preferences of the subscriber (e.g., the wireless subscriber 301).

As shown in FIG. 3, in the example where Party A 396 initiates the communications, the SRP 375 can select the message, announcement, or other output, and send that message, announcement, or output to the associated SSP upon receipt of information from the SMP 355. In the case where Party A 396 is calling the wireless subscriber 301, for example, the message, announcement, or other output would be provided to the FSC/SSP 325. The SSP 325 then plays or otherwise provides, the message, announcement, or other output for Party A 396 while the network 310 attempts to set up the call through the corresponding MSC/SSP 335 and BSS 315 to subscriber 301. The system illustrated in FIG. 3 will continue to play or provide the message, announcement, or other output, either in addition to ringing tones or in lieu of the ringing tones, as long as the subscriber 301 has not yet been connected to Party A 396. Upon completion of the call setup (e.g., upon the answering of the call by subscriber 301), the FSC/SSP 325 stops playing or providing the designated message, announcement, or other output to Party A 396, and connects Party A 396 to subscriber 301.

A similar process can be undertaken where Party B 397 initiates the communication. As illustrated in FIG. 3, Party B 397 communicates with the network 310 wirelessly. Signaling to and from the service execution environment (SEE) 350 by Party B 397 is handled by a corresponding MSC/SSP 335, which receives signals from Party B via the BSS 315.

The system illustrated in FIG. 3 also includes components that facilitate management of pre-connection messages output provided via the external specialized resource point (SRP) 375. In particular, it is possible to use additional environments, such as a service management environment (SME) 380 and a subscriber personalization environment (SPE) 390. These environments 380, 390 can be, for example, completely independent and separate entities, or they can be combined with one another in various manners depending upon the design constraints and desired functionality of the system of FIG. 3. These environments 380, 390 facilitate a subscriber, such as the wireless subscriber 301 or the wired subscriber 303 shown in FIG. 3, in accessing the pre-connection messaging or content output service. Additionally, or alternatively, these additional environments 380, 390 can define content to be played or provided to calling parties, as well as criteria under which particular messages, announcements, or other output can be played or provided to particular calling parties.

In the illustrated embodiment, a subscriber personalization environment (SPE) 390 provides system access to a subscriber through a subscriber portal or similar access point, whereby a subscriber can provide inputs to the service management environment (SME) 380, and in particular to a subscriber content and management component 385, which can manage content and management schemas, for example. The SPE 390 can provide one or more convenient techniques of providing inputs to the SME 380 and the subscriber content and management component 385. For example, the SPE 390 can provide access via computer 391 (e.g., Web-based access or other Internet-based access). Additionally, or alternatively, the SPE 390 can provide access via a wireless communication device 392 (e.g., using a wireless access protocol or WAP). Other techniques for accessing the subscriber content and management component 385 can be used, such as interactive voice response (IVR) or other similar techniques, for example. As illustrated, the SPE 390 can include a server 393 and/or one or more databases 394 that can be accessed in a variety of manners and using a variety of protocols (e.g., TCP/IP, WAP, IVR, etc.) by various devices, such as the computer 391 or the wireless communication device 392.

The subscriber personalization environment (SPE) 390 can be coupled to the subscriber content and management component 385 of the SME 380 via a firewall (FW) 387 to provide security as desired. The subscriber content and management component 385 can allow a given subscriber to identify that it wishes to be a subscriber for a particular message, announcement, or output (e.g., such as a feedback service) using either one of the interfaces through the subscriber personalization environment (SPE) 390. Arrangements also can be made for billing purposes through the subscriber content and management component 385. The subscriber content and management component 385 can track a subscriber by associating an identifier with the subscriber (e.g., a subscriber ID). The subscriber's identifier can be, for example, generated by the system, supplied by the subscriber, or based on an identifier already associated with the subscriber's communication equipment (e.g., telephone number, IP address, WAP ID, smart card ID, etc.).

In one variation, a subscriber can identify one or more communication devices as end points or destination devices associated with the subscriber for which a service (e.g., an intelligent network service) can be applied whenever any communication is attempted to any one of those devices. The subscriber can, therefore, have the opportunity to personalize service of the subscriber's devices in a number of different aspects. For instance, a subscriber applying a service (e.g., an IN service) to multiple communication devices can define a different set of rules to be applied to each of the communication devices, or a set of rules to be applied to a subset of communication devices. Thus, for example, if Party A 396 initiates a communication to a first one of a subscriber's communication devices (or a device having a first subscriber ID associated with the first communication device), then Party A 396 will receive a first message. If, on the other hand, Party A 396 initiates a communication to a second one of the subscriber's communication devices (or a device having a second subscriber ID associated with the second communication device), then Party A 396 will receive either the first message or a second different message.

Additionally, or alternatively, a subscriber can specify different messages, announcements, or other output to be played or provided to different calling parties. For example, the wired subscriber 303 may have identified both Party A 396 and Party B 397 as individuals to receive a particular announcement when they attempt to initiate a communication link (e.g., a telephone call) with the wired subscriber 303. Alternatively, the wired subscriber 303 may define different messages, announcements, or other output to be played or provided to Party A than the messages, announcements, or other output to be played or provided to Party B. The wired subscriber 303 can, on the other hand, elect to provide the same messages to all parties attempting to initiate a communication with the wired subscriber 303. The subscriber content and management module 385 preserves these rules, and a user of the system can change the rules by accessing the subscriber content and management module 385 (e.g., via the SPE 390).

The wired subscriber 303 can, for example, define particular messages, announcements, or other output via the SPE 390. Additionally, or alternatively, the subscriber 303 can be prompted to select messages or announcements from a menu of available messages, announcements, or other output. For example, the service management environment (SME) 380 can provide a standard list of musical selections or other audio output (e.g., messages) that are available for playback to calling parties and a subscriber can select one or more of those standard musical selections or other audio output to be relayed or provided to a calling party based on an association of a calling party identifier with a selected message. Alternatively, the system can allow a subscriber to upload a musical selection or message to the service management environment (SME) 380 via the subscriber personalization environment (SPE) 390. An uploaded pre-connection message or feedback announcement can be associated with a calling party identification number (e.g., a caller ID, etc.) in a manner similar to that described above.

Once a subscriber has identified the desired service and the appropriate associations have been defined as they relate to calling party identifications and particular messages, announcements, or other output, that information can be provided from the service management environment (SME) 380 via a security device such as a firewall (FW) 389 to the service execution environment (SEE) 350 via a service management interface (SMI) 365. The service management interface (SMI) 365 can, in turn, provide the messages to the external specialized resource point (SRP) 375. Additionally, the SMI 365 can help to populate databases or other data structures associated with the SMP 355 and/or define relationships between information stored in the databases or other data structures, such as called party identification information, calling party identification information, and particular types of messages, announcements, or other output that can be accessed and played or provided via the external specialized resource point (SRP) 375.

Each of the individual environments referred to above, such as the subscriber personalization environment (SPE) 390, the service management environment (SME) 380, and the service execution environment (SEE) 350, incorporate some computing and/or processing unit capabilities as well as memory. The computing and/or processing capabilities can be provided by a general processing computer with a memory configuration that provides sufficient arrangements for storing operating software as well as for storing subscriber-related, personalized service information. The SMP 355, for example, can include one or more databases that correlate information, such as subscriber identification information, number, or numbers (e.g., subscriber ID, called party ID, etc.) and one or more calling party numbers (e.g., calling party ID). For example, a subscriber can define a group of calling parties and associate a group identification number (e.g., group ID) with those calling parties. Using this group identification number, the subscriber (or another user) can identify or select a given message, announcement, or other output with the group identifier. Thus, once the SCP 345 receives the called party and calling party identification numbers (e.g., during the process of a telephone call setup), the SMP can determine an identification of the appropriate message, announcement, or other output to be relayed to the calling party based on the subscriber's prior choices and/or selections.

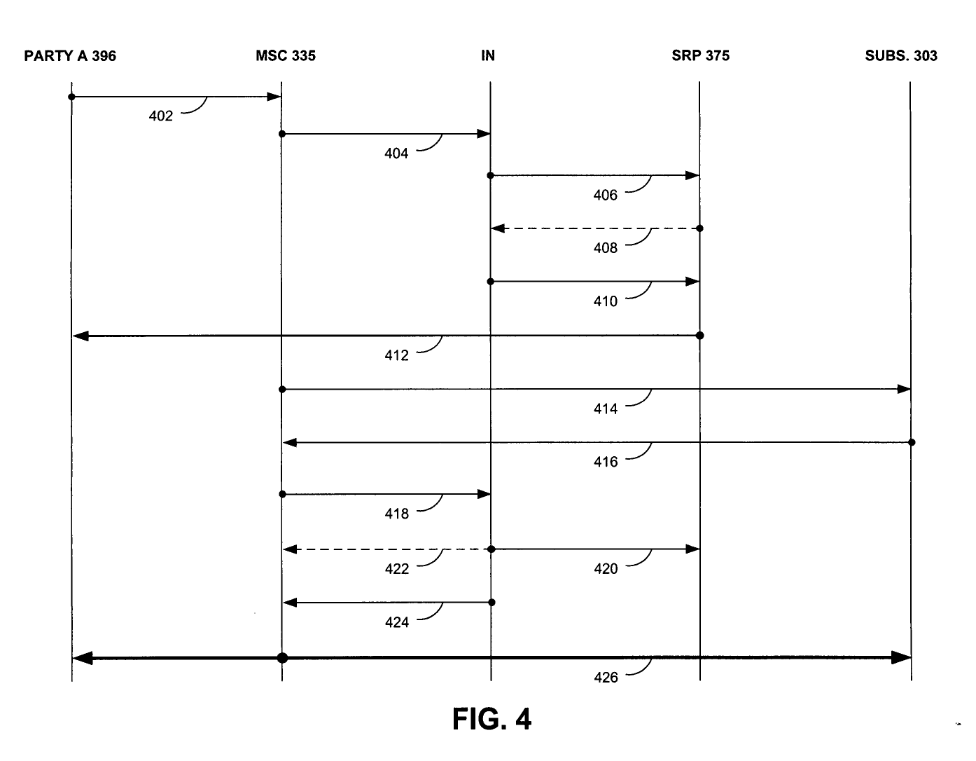

FIG. 4 illustrates a call processing operation according to an embodiment of the invention. More specifically, FIG. 4 provides a call setup flow diagram in connection with an example of an execution of the present invention. In the example illustrated in FIG. 4, Party A 396 (shown in FIG. 3) attempts to place a call to a wired subscriber 303 (shown in FIG. 3).

After dialing, the number dialed by Party A 396 (e.g., the telephone number of the subscriber 303) is sent via the BSS 315 (shown in FIG. 3) to MSC 335 in operation 402. The MSC/SSP 335 (shown in FIG. 3) recognizes the called party number (e.g., the telephone number or called party ID of the wired subscriber 303) as belonging to a subscriber of an intelligent network service. Accordingly, the MSC/SSP 335 signals the intelligent network (IN) in operation 404, providing both the called party number and the calling party number to the intelligent network (IN) infrastructure by sending or signaling to, for example, the service control point (SCP) 345 (shown in FIG. 3). The intelligent network (IN) checks the identification number of the calling party (e.g., the telephone number or ID of Party A 396) and the identification number of the called party (e.g., the number or ID of the wired subscriber 303) using information stored by and/or at the service management point (SMP) 355 (shown in FIG. 3) in operation 406 to select an appropriate message, announcement, or other output to be delivered to Party A 396.

The message, announcement, or other output can be, for example, determined by the intelligent network (IN) based on signals optionally received from an external specialized resource point (SRP) 375 in optional operation 408. Alternatively, this information can be determined by the SRP 375 based on information received from the intelligent network (IN) in operation 406. The intelligent network (IN) then instructs the SRP 375 in operation 410 to play or provide the selected message, announcement, or other output to the calling party (e.g., Party A 396). That information is provided by the SRP 375 to the calling party (e.g., Party A 396) in operation 412, and can optionally be provided via the MSC 335 (e.g., using the MSC 335 as an intermediary between the SRP 375 and the calling party). The MSC 335, concurrently with the playing or providing of the message, announcement or other output in operation 412, attempts in operation 414 to establish the setup to the subscriber 303 via the communication network 310 (e.g., attempting to initiate a communications link, such as a telephone call by a paging signal, etc.).

As the MSC 335 sets up the connection between the calling party (Party A 396) and the called party (the subscriber 303) in operation 414, the SRP 375 continues to play or provide the message, announcement, or other output in operation 412 to the calling party (Party A 396). The message, announcement, or other output played or provided in operation 412 is played or provided based on its selection or determination by the intelligent network (IN) or the SRP 375, and also based on an association of the same information with the calling party (e.g., using a calling party ID or a group ID of a group that includes the calling party). Once the called party (e.g., the subscriber 303) answers the call, signaling (e.g., an acknowledge or ACK signal) is provided by equipment associated with the called party (e.g., the subscriber 303) to the MSC 335 in operation 416, indicating that the call has been answered. Upon receipt of the indication that the called party (e.g., the subscriber 303) has answered the call, the MSC 335 signals to the intelligent network (IN) in operation 418 that the subscriber 303 has answered.

When the intelligent network (IN) is signaled that the called party (e.g., the subscriber 303) has answered the call, the IN then commands the SRP 375 in operation 420 to halt playing of the message, announcement, or other output. This can either take place by a signal to the SRP 375 in operation 420 to halt playing or, alternatively, by a signal from the IN to the MSC 335 in optional operation 422 to advise the MSC 335 to stop playing or providing a message, announcement, or other output previously and optionally downloaded from the SRP 375. The halting of the message, announcement, or other output can be immediate, or can occur at the next logical stopping point in the message, announcement or other output. When the message, announcement, or other output is stopped, the intelligent network (IN) sends an instruction to the MSC 335 in operation 424 to connect the calling party (Party A 396) to the called party (the subscriber 303). In response to the instruction for connection, the MSC 335 opens a voice channel 426 between the calling party (Party A 396) and the called party (the subscriber 303).

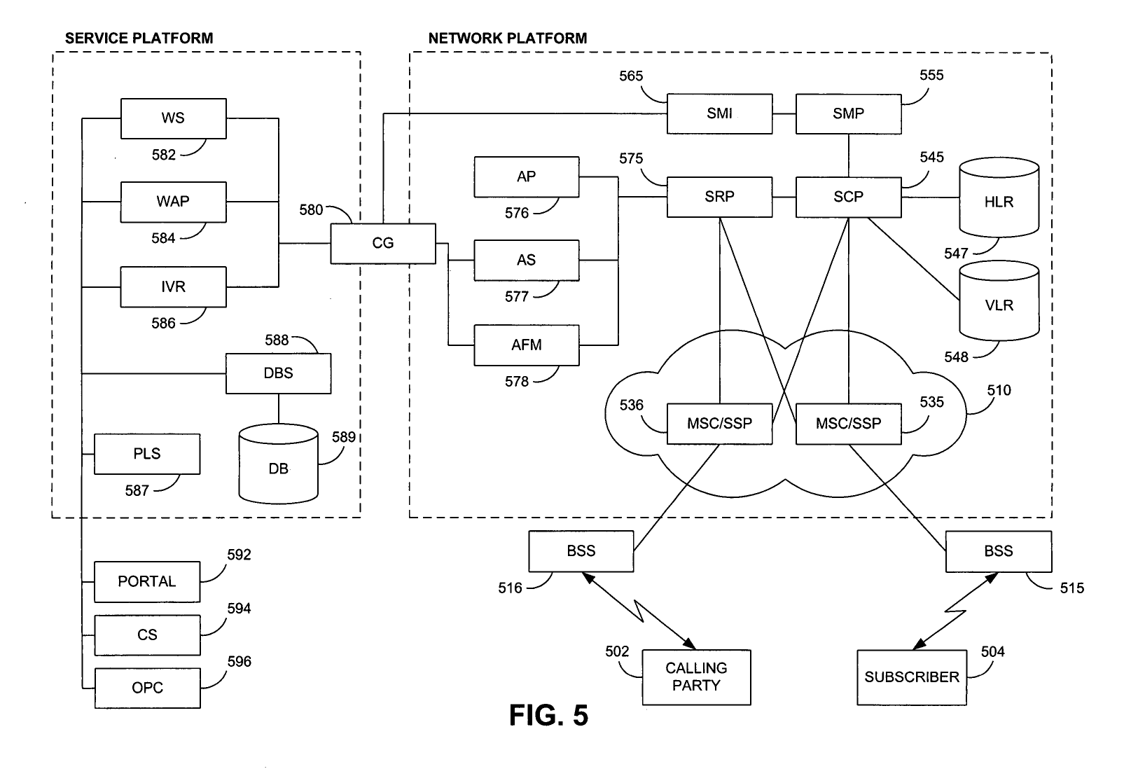

FIG. 5 is a block diagram illustrating a network arrangement according to an embodiment of the invention. More specifically, FIG. 5 is a block diagram of a specific implementation configured to provide audio output to a calling party, while the calling party is awaiting an answer by the called party via the network. Many of the various components illustrated in the block diagram of FIG. 5 are divided into two main categories: network platform components and service platform components. The components of the network platform provide telecommunications functionality to one or more calling parties, called parties, and/or subscribers. The components of the service platform, on the other hand, provide access to additional services associated with the network 510 for subscribers of that network 510. For example, by way of the service platform and its components, a user (e.g., a subscriber) can create and/or select a message, announcement, or other output to be provided to one or more calling parties, when the one or more calling parties attempt to communicate with a subscriber via the network 510.

Some components of the network platform are similar to the various embodiments described above. For example, a network 510 is an intelligent network (IN) (e.g., an SS7 network, etc.), and can include, for example, one or more MSC/SSP components 535, 536, by which devices connecting to the network 510 can communicate with other devices connected to the network 510. For example, a calling party 502, which may or may not subscribe to the services of the network 510 can attempt to place a call via the network 510 in an attempt to reach a subscriber 504 of the network. As with the various embodiments described above, this can be accomplished using a wireless communications device, which connects to the network 510 by way of a base station subsystem (BSS) 516. Likewise, a subscriber using a wireless communications device can also connect to the network 510 by way of a BSS 515, which can be the same as or different from the BSS 516 by which the calling party 502 accesses the network 510.

As with the various embodiments described above, the MSC 535, 536 communicates with an SCP 545 to facilitate a call from a calling party 502. The SCP 545, as above, also communicates with the SMP 555, to which the SCP 545 sends queries regarding service for the calling party 502. In a similar manner to the embodiments described above, the SMP 555 communicates with an SMI 565.

Additionally, the SCP 545 can communicate with one or more databases. For example, the SCP 545 can communicate with a home location register (HLR) 547, which can be, for example, a database that contains all of the subscribers within the local network or service area. Additionally, or alternatively, the SCP can communicate with one or more databases. For example, the SCP 545 can communicate with a visitor location register (VLR) 548, which can be, for example, a database that contains all of the visitors currently visiting within the local network or service area. By way of the SCP 545, all incoming calls from calling parties 502 can first be queried against the HLR database 547 and/or the VLR database to determine if the party being called is local to the network 510. By using the HLR 547 and/or the VLR 548, the network 510 can avoid using external switches and bandwidth to route calls outside of the network 510, processing calls to locally situated devices entirely within the network 510.

In the embodiment illustrated in FIG. 5, the specialized resource point (SRP) 575 can communicate with one or more service components that are configured to provide services within the network platform. As with the examples above, the SMP 555 can request that one or more messages, announcements, or other output be provided by way of the SRP 575 to one or more devices in communication with the network 510. In the embodiment illustrated in FIG. 5, the SRP 575 is configured to provide audio output to the calling party 502, while a communication link with the subscriber 504 is being established or, in other words, while a call setup procedure is being performed. This audio output is provided during the call setup procedure, including up to the time when the call is answered by the subscriber 504.

To facilitate the SRP 575 in providing audio content to one or more devices connected to the network 510, several components are accessible to and in communication with the SRP 575 within the network platform. For example, the SRP 575 can communicate with an audio player 576 that is configured to play audio sounds and/or provide audio output to be played to the SRP 575, which in turn can provide the audio output to the calling party 502 via the appropriate MSC 536 and BSS 516. Audio output played by the audio player (AP) 576 can be served to the SRP 575 by an audio server (AS) 577. Additionally, an audio file manager (AFM) 578 is also provided, and can manage pre-stored audio files, uploaded audio files, audio files otherwise transferred by one or more subscribers 504 of the network 510, or audio files received from one or more users accessing functionality of the network 510 via the service platform. Devices of the network platform can communicate with devices of the service platform by way of a common gateway (CG) 580, which allows for communications between devices on both platforms. This common gateway (CG) 580 can be any number of suitable network or communications gateways configured to communicate between two or more devices in a communications or computer network, and which is configured to communicate using the protocol(s) of the devices of the network platform and/or the service platform.

For example, the common gateway (CG) 580 can communicate between the various devices of the network platform and one or more servers, such as a web server (WS) 582, a wireless application protocol (WAP) server 584, and/or an interactive voice response (IVR) server 586 of the service platform. Each of these servers 582, 584, 586 can also communicate with other devices within the service platform. For example, to provide additional services, one or more database servers (DBS) 588 can communicate with the aforementioned servers 582, 584, 586 and/or devices external to the service platform, allowing it to thereby be accessed by one or more users. Moreover, each of the one or more database servers (DBS) 588 can communicate with one or more databases (DBs) 589 to obtain information necessary or desirable to the functionality of the network 510.

In addition, the various servers, including the web server 582, the wireless application protocol server 584, the interactive voice response server 586, and the database server 588, can all communicate with a pre-listening server (PLS) 587, which is configured to provide information concerning any audio to be output via the network 510, and/or to provide previews of the audio output to one or more devices accessing the pre-listening server (PLS) 587 from outside of the service platform. For example, the PLS 587 can serve as a staging area for audio output being uploaded and/or selected by one or more users.

Users can access functionality of the devices of the service platform and, indirectly via the service platform, the functionality of the devices of the network platform in one or more ways. For example, one or more subscribers of the network 510 can access the service platform and its various devices via a portal 592, which communicates with the various components of the service platform. This can include, for example, a standard computer, which can communicate with the web server 582 of the service platform. Additionally, a user can access the service platform and its functionality by way of a wireless communication device. For example, a wireless device using WAP can access the functionality of the service platform via the WAP server 584 by way of the portal 592 or the network 510 (using the CG 580). Additionally, customers can access functionality of the system using the interactive voice response (IVR) server 586 by way of the portal 592 or the network 510 (using the CG 580). This can be useful, for example, for users requiring a hands-free method for accessing the functionality available from the service platform. Using the IVR server 586, for example, a user can perform all of the functions that can be performed using the web server 582 or the WAP server 584, but can issue commands to the system using voice commands.

In addition to a portal 592 that allows subscribers to access the service platform and its functionality in an effort to customize the operation of the network 510 as it pertains to a particular subscriber, one or more customer service entities 594 can access any of the servers of the service platform. By way of a customer service entry point 594, for example, a customer service representative can provide service to subscribers 504 of the network 510, and/or service to users having difficulty accessing the service platform via the portal 592. Likewise, an operations center (OPC) entry point 596 is provided to allow properly authorized and designated individuals, such as system administrators or the like, to access the service platform and all of its functionality. Accordingly, system administrators can access a service platform either by way of the customer service (CS) entry point 594 or by way of the operations center (OPC) entry point 596, depending upon system rules or constraints, for example. By way of the operations center entry point 596, for example, any network communications system that uses managed network services (e.g., provided using a network operations center or NOC) can allow the managed network service providers to access the service platform and the various functionalities of the network 510 by way of the operations center (OPC) entry point 596.

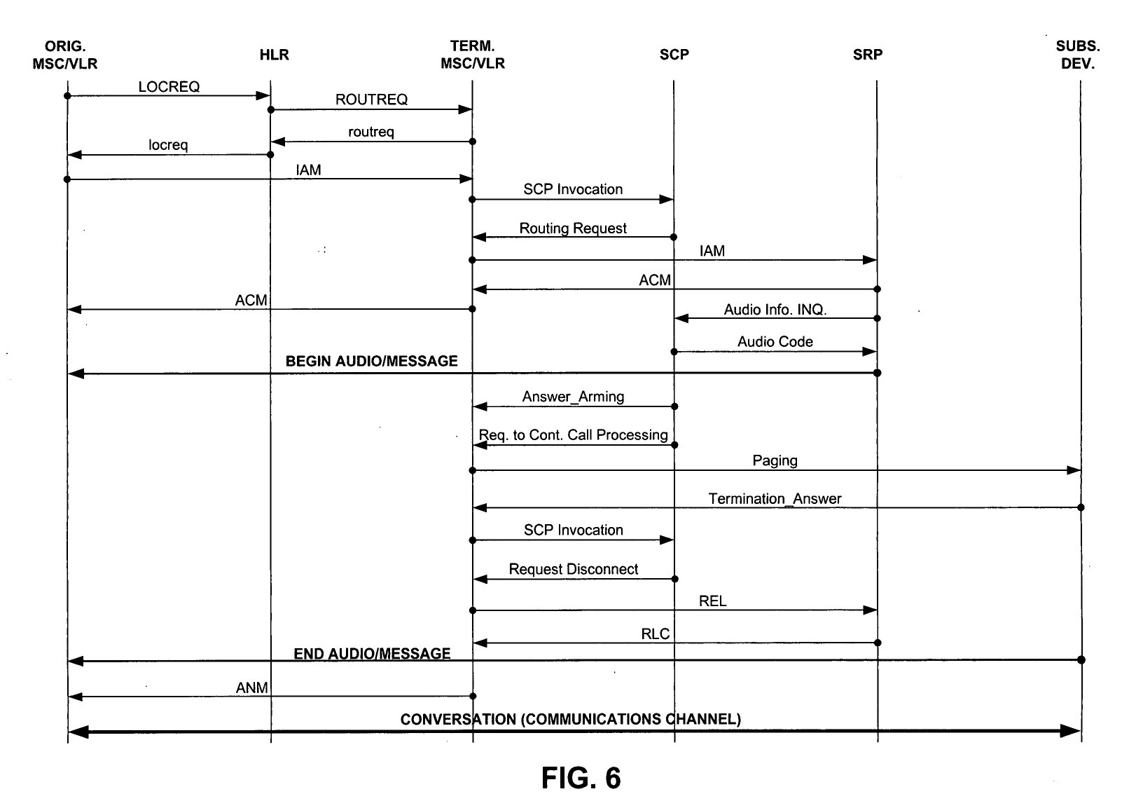

FIG. 6 illustrates a call processing operation according to an embodiment of the invention. The call processing operation illustrated in FIG. 6 is an example of a call processing operation that can be used with audio output to be provided as a personalized ringback tone (PRBT) (e.g., a music selection, etc.), or an audio output provided to a calling party while the calling party is awaiting connection with the called party.

In FIG. 6, various communications signals are illustrated between various entities, each of which is represented by a vertical line, and each line is labeled at the top of the figure. For example, the left-most line represents an originating MSC (e.g., the MSC/SSP 536 shown in FIG. 5) or visitor location register (VLR) (e.g., the VLR 548 shown in FIG. 5). Other entities involved in the operation illustrated in FIG. 6, each of which is represented by an individual vertical line, include the home location register (HLR) (e.g., the HLR 547 shown in FIG. 5), the terminating MSC (e.g., the MSC/SSP 535 shown in FIG. 5) or VLR (e.g., the VLR 548 shown in FIG. 5), the SCP (e.g., the SCP 545 shown in FIG. 5), the SRP (e.g., the SRP 575 shown in FIG. 5), and the device of the subscriber (e.g., the subscriber 504 shown in FIG. 5).

When a call is initiated by a calling party 502 (shown in FIG. 5), a location request (LOCREQ) query signal is provided from the originating MSC/VLR to the HLR. The HLR, in turn, transmits a route request (ROUTREQ) query signal to the termination MSC/VLR. The termination MSC/VLR responds with a route request (routreq) response signal to the HLR, which in turn provides the originating MSC/VLR with a location request (locreq) response signal. Upon receiving the location request response signal, the originating MSC/VLR initiates communications by providing an initial address message (IAM) signal to the termination MSC/VLR. Upon receiving the IAM signal, the termination MSC/VLR authorizes the attempt by the originating MSC/VLR to communicate directly with the termination MSC/VLR. This authorization can include additional signals not shown in FIG. 6, to perform a standard authorization of the originating MSC/VLR, or such authorization can be performed entirely within the termination MSC/VLR itself.

The termination MSC/VLR then sends an SCP invocation signal to the SCP (e.g., the SCP 545 of FIG. 5). The SCP returns a routing request signal to the termination MSC/VLR, whereupon the termination MSC/VLR provides an initial address message (IAM) signal to the specialized resource point (SRP) (e.g., such as the SRP 575 shown in FIG. 5). This information can be either provided directly to the SRP, or by way of other devices, such as the SMP 555 (shown in FIG. 5) and/or the SMI 565 (shown in FIG. 5) or other devices.

When the SRP has received the IAM signal from the termination MSC/VLR, the SRP transmits an address complete message (ACM) signal in response to the IAM signal. The SRP then provides an audio information inquiry (INQ) to the SCP, which is answered by the SCP returning an audio code signal to the SRP. The SRP then begins to cause the audio identified in the audio code signal received from the SCP to be output to the originating MSC/VLR, which causes the device of the calling party to output the audio to be output. In other words, the SRP causes a personalized ringback tone (PRBT) or other audio output or message to be played via the originating MSC/VLR to the calling party 502 during the call setup procedure. As the audio signal is being relayed via the originating MSC/VLR, the SCP provides an Answer_Arming signal to the termination MSC/VLR. Additionally, the SCP sends a request signal requesting the termination MSC/VLR to continue call processing. The additional call processing that happens after the audio/message output is begun occurs while audio output is being relayed via the originating MSC/VLR to the calling party 502 (shown in FIG. 5), and continues until the call is answered by the subscriber.

Once the termination MSC/VLR has received the request to continue call processing, the termination MSC/VLR provides a Paging signal to the subscriber's device. The termination MSC/VLR is answered using a Termination_Answer signal by the subscriber's device. Upon receipt of this answer signal, the termination MSC/VLR again sends an SCP invocation signal to the SCP. In response to this invocation signal, the SCP requests to disconnect from the termination MSC/VLR. The termination MSC/VLR then sends a release (REL) signal to the SRP, which confirms the release signal by providing a radio link control (RLC) response signal to the termination MSC/VLR. The SRP then ends the audio signal or message being relayed via the originating MSC/VLR. As discussed above, the audio/message output can be ended immediately, after a pre-determined length, or at a suitable stopping point, which may be predetermined.

Once the audio/message output has been ended, an answer message (ANM) response signal is transmitted from the termination MSC/VLR to the originating MSC/VLR, and a conversation is then possible by way of the communications channel formed between the calling party 502 (shown in FIG. 5) via the originating MSC/VLR and the subscriber 504 (shown in FIG. 5) via the termination MSC/VLR.

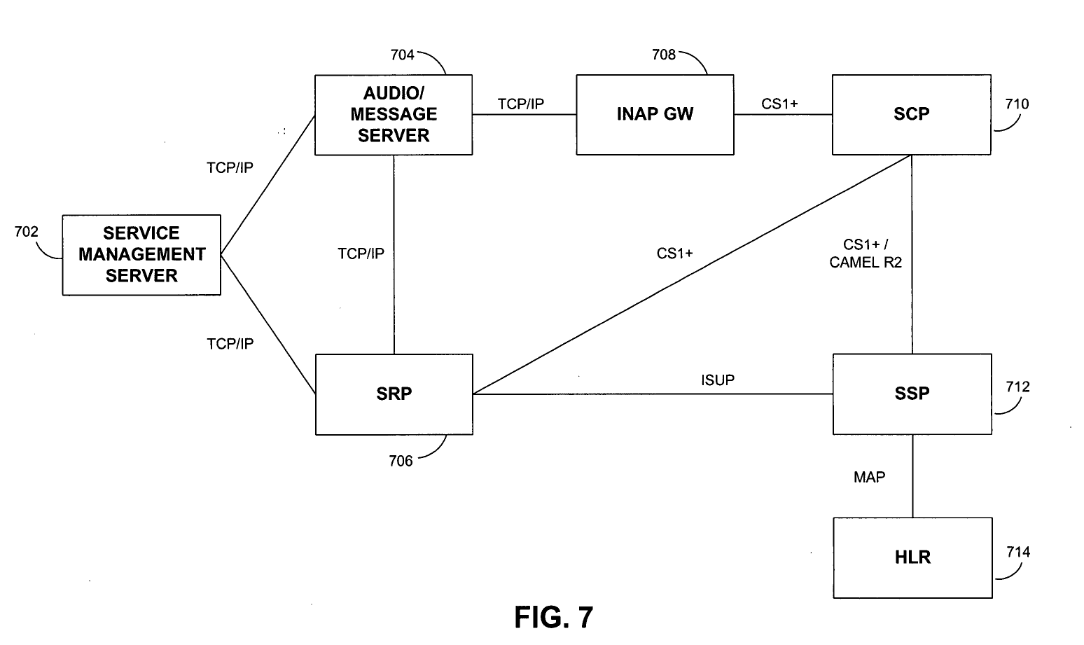

FIG. 7 is a block diagram showing network components and communications protocols used by those components according to an embodiment of the invention. Although other protocols and network components can be used, those shown in FIG. 7 are used by way of example. In FIG. 7, a service management server (sometimes referred to as SMS) 702 is illustrated in communication with an audio/message server 704 and an SRP 706. The service management server 702 can be used, for example to communicate local number portability (LNP) and/or pooling information between carriers. In the example shown in FIG. 7, the service management server 702 communicates with both the audio/message server 704 and the SRP 706 using a standard network protocol, such as transmission control protocol and/or Internet protocol (TCP/IP). Additionally, the audio/message server 704 and the SRP 706 are in communication, and can communicate using similar protocols, such as TCP/IP, as shown in FIG. 7.

When the service management server 702 is utilized in an intelligent network (IN), such as an SS7 network, for example, or other similar intelligent networks, the audio/message server 704 can access various devices within the IN via an intelligent network application part (INAP) gateway (GW) 708. This gateway can translate requests from the audio/message server 704 from standard computer networking protocols such as TCP/IP to a telecommunications protocol, such as capability set 1 (CS-1) or CS1+. For example, the INAP GW 708 can allow communications between the audio/message server 704 and a service control point (SCP) 710. The SRP 706 can also communicate using a telecommunications protocol, such as CS-1 or CS1+, for example. Moreover, the SRP 706 can communicate directly with the SCP 710, or other devices using the same telecommunications protocol (e.g., CS1+). For example, the SRP 706 can also communicate with an SSP 712, or other switch using a telecommunications protocol suitable for communicating among switches, such as an integrated services digital network user part (ISUP), which can be used to signal between switches in an SS7 or other IN, for example.

As illustrated in FIG. 7, the SCP 710 can communicate with the SSP 712 using one or more suitable telecommunications protocols, such as CS1+, or a customized applications for mobile networks enhanced logic (CAMEL), CAMEL R2, or another suitable communications protocol. The SSP 712 can query the HLR 714 using a suitable telephone system communications protocol, such as the mobile application part (MAP) protocol, for example.

From the foregoing, it can be seen that one or more embodiments of the invention allows a subscriber to selectively designate messages, announcements, or other output to be relayed to a party attempting to establish communications with the subscriber. These messages, announcements, or other output are played or provided to an initiating party while the connection is being set up or, in other words, while a communication link (e.g., a telephone call) is being established. One environment in which this is useful is in a telecommunications environment employing an intelligent network (IN) whereby there already exists the capacity to analyze incoming calls into the network and select pieces of information related to the call and use those pieces to help define features or functionality which might be provided to the caller either during setup or after setup. This invention also is applicable, however, in other environments where there is a process required in setting up a communication link between an initiating party and a party to be contacted and where the setup time is of sufficient length to merit some message (e.g., a feedback message) or output to the initiating party while the setup is going on.

As described above, the playback announcement or feedback message can be strictly an audio message (e.g., verbal or musical), or it can be a visual message (e.g., video), such as in an environment where a video link is being established or where the calling party has the capacity to receive video information and display it while awaiting connection to the desired destination party. As also indicated above, the messages can take the form of music or other types of messages or output (e.g., audio output) that might be relayed to the calling party based on the subscriber's selections or predefined preferences associated with a initiating or calling party.

Thus, in accordance with one or more embodiments of the invention, a party initiating the call or communication will receive information while the network sets up the call, the information presented being based on selections made by the called party in setting up a subscriber service. As a consequence the subscriber can personalize the information provided to the calling party during a call setup or communication setup process.

The presently disclosed embodiments are considered in all respects to be illustrative and not restrictive.

1. A method for processing a communication request from a first party comprising:
receiving an identifier associated with a party to be contacted;
using said identifier to determine a level of service to be provided on behalf of the party associated with said identifier;
in response to determining a level of service, retrieving an announcement;
initiating a sending of the selected announcement to the first party;
detecting availability of the party to be contacted;
in response to said detecting availability establishing a connection for a communication path between the first party and the party to be contacted.

2. The method of claim 1 wherein said establishing a connection includes stopping a sending of said selected announcement.

3. The method of claim 1 wherein said selected announcement comprises a message selected by the party to be contacted.

4. The method of claim 3 wherein said message includes an audio selection.

5. The method of claim 3 further comprising
receiving identification information associated with the first party;
recognizing the first party as a party to receive a selected message using the identification information associated with the first party; and
selecting the message using information concerning the identity of the first party.

6. A method for processing a telephone call from a calling party to a called party, comprising:
receiving a called party identifier;
recognizing the called party identifier as being associated with an intelligent network service;
receiving a calling party identifier;
selecting a pre-connection announcement for transmission to the calling party depending on the calling party identifier and the associated intelligent network;
sending the selected pre-connection announcement to the calling party;
receiving a connection ready notice from the called party;
establishing a connection between the calling and called party upon receiving said connection ready notice.

7. The method of claim 6 wherein said selected pre-connection announcement includes an audio message.

8. The method of claim 6 wherein said selected pre-connection announcement includes a video portion.

9. A method for personalizing feedback to a calling party in an intelligent network, the method comprising:
recognizing a party as a subscriber to the intelligent network;
presenting feedback announcement selection options to the subscriber;
receiving a first feedback announcement selection from the subscriber;
receiving information identifying a first caller to receive the selected first feedback announcement; and
associating said first feedback announcement and the information identifying the caller with the subscriber.

10. The method of claim 9 further comprising:
receiving a second feedback announcement selection from the subscriber;
receiving information identifying a second caller to receive the selected second feedback announcement; and
associating said second feedback announcement and the information identifying the second caller with the subscriber.

11. The method of claim 9 further comprising:
receiving information identifying a second caller to receive the selected first feedback announcement; and
creating a first caller group based on the first caller and the second caller.

12. The method of claim 9 further comprising:
receiving a called party identifier;
recognizing the called party as the subscriber to the intelligent network;
receiving a calling party identifier;
determining that said calling party identifier corresponds to the first caller; and
sending the selected first feedback announcement to the first caller prior to connecting the first caller to the subscriber.

13. The method of claim 12 wherein said first feedback announcement includes a video message.

14. The method of claim 12 wherein said first feedback announcement includes an audio message.

15. In a system for processing telephone calls from a first party to a second party, apparatus comprising:
an announcement storage system storing a plurality of feedback announcements;
a subscriber database storing information regarding a plurality of subscribers including a subscriber identifier, a calling party identifier and a feedback announcement identifier;
a controller coupled to said announcement storage system and said subscriber database and adapted to receive a calling party identifier during setup of a call from the first party to the second party; and
an announcement playback device coupled to said controller and adapted to direct a selected feedback announcement to a calling party during setup of a call from a first party to a second party based on a calling party identifier.

16. The apparatus of claim 15 wherein said selected feedback announcement includes an audio selection.

17. The apparatus of claim 15 further comprising:
a subscriber and content manager coupled to said subscriber database and being adapted to receive subscriber generated information for defining subscriber database content.

18. The system of claim 17 further comprising a content processor coupled to said announcement storage system and being adapted to receive announcement content from a subscriber for storage in said announcement storage system.

19. In a communication system for setting up calls between a calling party and a called party, an apparatus comprising
a service control point adapted to receive a call setup request for setting up a call between a calling party and a called party; and
a specialized resource point coupled to said service control point and containing information identifying resource allocations on behalf of a called party in response to information regarding the calling party;
wherein resources for allocation include audio messages for selected playback to a calling party during call setup.

20. The apparatus of claim 19 further comprising a playback control mechanism adapted to initiate playback of a selected audio message during call setup and further adapted to halt playback of the selected audio message upon completion of call setup.
